(19) United States
(12) Patent Application Publication
(10) Pub. No.: US 2007/0231645 A1
(43) Pub. Date: Oct. 4, 2007

(54) Fuel cell system and method of controlling operation of the same

(76) Inventor: Terumasa Nagasaki, Tokyo (JP)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/731,108

(22) Filed: Mar. 30, 2007

(30) Foreign Application Priority Data
Mar. 31, 2006 (JP) 2006-100186

(51) Int. Cl. H01M 8/04

(52) U.S. Cl. 429/23; 429/38; 429/13

(57) ABSTRACT

A fuel cell system includes an information processor and a fuel cell unit connected to the information processor. The fuel cell unit has a cell stack which includes a plurality of single cells stacked in layers on one another, a fuel passage, and an air passage, and generates electric power based on a chemical reaction, a fuel supply section which supplies a fuel to the anode through the fuel passage, and an air supply section which supplies air to the cathode through the air passage. The information processor has a power controller which manages an operation of the fuel cell unit. The power controller stops power generation in the cell stack and executes maintenance processing such that air from the air supply section is caused to flow through the air passage of the cell stack, when generated power output of the cell stack is lower than a predetermined output.

### CROSS-REFERENCE TO RELATED APPLICATIONS

This application is based upon and claims the benefit of priority from Japanese Patent Application No. 2006-100186, filed Mar. 31, 2006, the entire contents of which are incorporated herein by reference.

### BACKGROUND

1. Field

An embodiment of this invention relates to a fuel cell system provided with a fuel cell unit for use as a power source for an electronic device or the like and a method of controlling the operation of the fuel cell system.

2. Description of the Related Art

Presently, secondary batteries, such as lithium ion batteries, are mainly used as power sources for portable notebook type personal computers (notebook PCs), mobile devices, etc. In recent years, small-sized, high-output fuel cells that require no charging have been expected as new power sources to meet the demands for increased power consumption and prolonged use of these electronic devices with higher functions. Among various types of fuel cells, direct methanol fuel cells (DMFCs) that use methanol as a fuel, in particular, enable easier handling of the fuel and a simpler system configuration, as compared with fuel cells that use hydrogen as their fuel. Thus, the DMFCs are noticeable power sources for the electronic devices.

A fuel cell disclosed in Jpn. Pat. Appln. KOKAI Publication No. 2005-293981, for example, has a cell stack having single cells and separators that are alternately stacked in layers. Each single cell is composed of an electrolyte layer, such as an electrolyte plate or a solid polymer electrolyte membrane permeable to hydrogen ions (protons), which is sandwiched between two electrodes. Each separator has a groove for use as a reaction gas passage. Each single cell is provided with a membrane electrode assembly (MEA), which integrally comprises an anode (fuel electrode) and a cathode (air electrode) each formed of a catalyst layer and a carbon paper. The anode and the cathode are disposed individually on the opposite surfaces of a polymer electrolyte membrane. An aqueous methanol solution with a concentration of several to tens of percent is supplied to the anode through a passage in the cell stack, and air to the cathode.

Oxidation of a fuel occurs in the anode. Specifically, methanol is oxidized by reaction with water, whereupon carbon dioxide, protons, electrons are produced. The protons move to the cathode through the polymer electrolyte membrane. In the cathode, oxygen gas in the air is combined with hydrogen ions and electrons and reduced to generate water. As this is done, the electrons flow into an external circuit, and current is taken out.

The fuel cell constructed in this manner is supposed to undergo degradation in performance, that is, reduction in power generation output, mainly due to the following three factors:

(1) activation polarization or voltage drop attributable to reduction in catalyst activity, conspicuous in a high-voltage region;

(2) resistance polarization or voltage drop attributable to the electrical resistance of the MEA, conspicuous in a medium-voltage region; and

(3) diffusion polarization or voltage loss attributable to reluctance to fuel diffusion, conspicuous in a low-voltage region.

Among these degradation factors, the polarizations (1) and (2) cannot be easily recovered, since they are attributable to degradation of the catalyst or the MEA itself. The polarization (3) can be recovered, since it is supposed to occur because water generated mainly at the cathode stands in a passage so that air cannot permeate into the MEA.

In the case of a large-sized fuel cell system provided with a nitrogen supply tank or the like, as disclosed in Jpn. Pat. Appln. KOKAI Publication No. 7-307161, for example, its operation is restarted after it is suspended and a cathode electrode is purged with nitrogen gas if an output reduction is caused by an excessive leakage from a cathode catalyst layer.

The fuel cell is often used in a low-voltage region for higher output. Accordingly, recovery processing for the diffusion polarization is supposed to be effective means for restoring the performance of the fuel cell. If the nitrogen supply tank or the like is provided for a small-sized fuel cell that is used as a power source for a portable or miniature electronic device, such as a note PC or a mobile device, however, the configuration is complicated, and the entire device is increased in size. Thus, the above-described configuration is not easily applicable, so that it cannot be regarded as effective means.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view showing a fuel cell unit of a fuel cell system according to an embodiment of the invention;

FIG. 2 is an exemplary perspective view showing the fuel cell system;

FIG. 3 is an exemplary system diagram mainly showing the internal structure of a power generator of the fuel cell unit;

FIG. 4 is an exemplary sectional view showing a DMFC stack of the fuel cell unit;

FIG. 5 is an exemplary view schematically showing a single cell of the DMFC stack;

FIG. 6 is an exemplary system diagram showing a state in which an information processor is connected to the fuel cell unit;

FIG. 7 is an exemplary system diagram showing the configuration of the fuel cell unit and the information processor;

FIG. 8 shows characteristic curves representing current-voltage characteristics of the DMFC stack;

FIG. 9 is an exemplary flowchart showing recovery processing for the fuel cell system; and

FIG. 10 is an exemplary flowchart showing recovery processing according to another embodiment of the fuel cell system.

### DETAILED DESCRIPTION

Various embodiments according to the invention will be described hereinafter with reference to the accompanying drawings. In general, according to one embodiment of the invention, there is provided a fuel cell system comprising an information processor, and a fuel cell unit connected to the information processor; the fuel cell unit including:

a cell stack which comprises a plurality of single cells, stacked in layers on one another and each having an anode and a cathode opposed to each other, a fuel passage through which a fuel is supplied to the anode, and an air passage through which air is supplied to the cathode, and generates electric power based on a chemical reaction, a fuel supply section which supplies a fuel to the anode through the fuel passage, an air supply section which supplies air to the cathode through the air passage, and a cell controller which detects a generated power output of the cell stack and controls operations of the fuel supply section and the air supply section,

the information processor including an input section through which information is inputted, a display section which displays the information, and a power controller which manages an operation of the fuel cell unit, the power controller being configured to stop power generation in the cell stack and execute maintenance processing wherein air from the air supply section is caused to flow through the air passage of the cell stack, when the generated power output of the cell stack is lower than a predetermined output.

According to one embodiment of the invention, there is provided a method of controlling an operation of a fuel cell system which comprises an fuel cell unit, including a cell stack which has a plurality of single cells, stacked in layers on one another and each having an anode and a cathode opposed to each other, a fuel passage through which a fuel is supplied to the anode, and an air passage through which air is supplied to the cathode, and generates electric power based on a chemical reaction, a fuel supply section which supplies the fuel to the anode through the fuel passage, an air supply section which supplies air to the cathode through the air passage, and a cell controller which detects a generated power output of the cell stack and controls operations of the fuel supply section and the air supply section; and an information processor which includes an input section through which information is inputted, a display section which displays the information, and a power controller which manages an operation of the fuel cell unit, and is connected to the fuel cell unit, the method comprising:

detecting the generated power output of the cell stack; and stopping power generation in the cell stack by the power controller and executing maintenance processing wherein air from the air supply section is caused to flow through the air passage of the cell stack, when the generated power output of the cell stack is lower than a predetermined output.

A fuel cell system according to an embodiment of the present invention will now be described in detail with reference to the accompanying drawings.

The fuel cell system according to the present embodiment comprises a fuel cell unit and an information processor, e.g., a notebook personal computer, which receives electric power supply from the fuel cell unit.

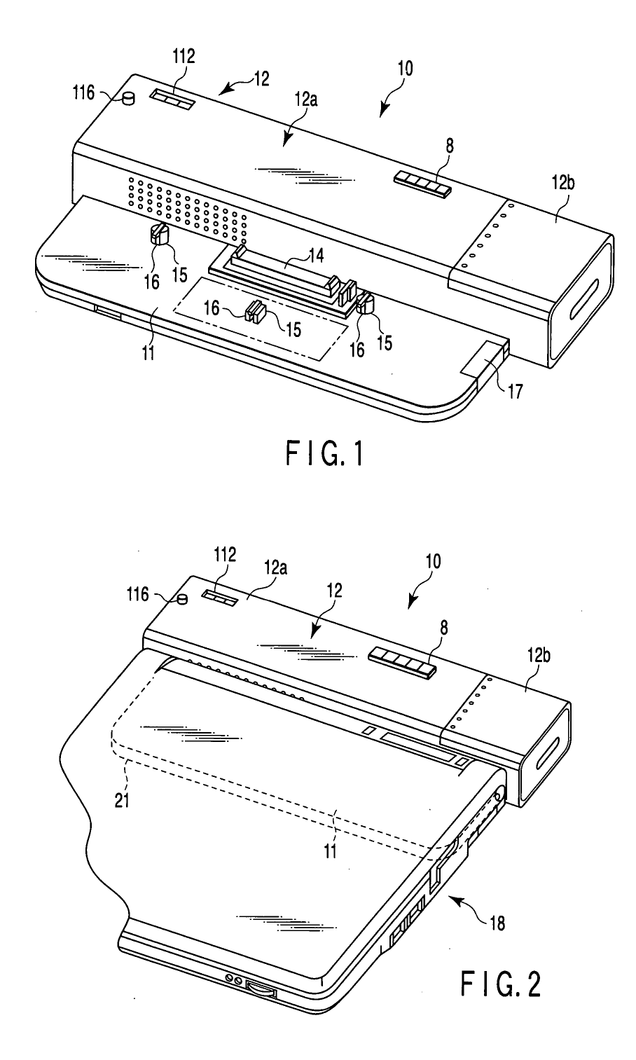

FIG. 1 is an exemplary external view showing a fuel cell unit 10, and FIG. 2 is an exemplary external view showing the fuel cell unit and an information processor 18 connected to it. As shown in FIG. 1, the fuel cell unit 10 includes a mounting platform 11 on which the rear part of the information processor is set and a fuel cell unit body 12. As described later, the fuel cell unit body 12 contains therein a DMFC stack for power generation based on an electrochemical reaction and various accessories for injecting into and circulating methanol and air that form a fuel in the DMFC stack.

The fuel cell unit body 12 comprises a unit case 12a, and a removable fuel cartridge is held in, for example, the left-hand end part of the unit case. A part of the unit case 12a constitutes a detachable cover 12b that facilitates the fuel cartridge to be replaced with a new one.

A power generation setting switch 112 and a fuel cell operation switch 116 are provided on, for example, one end portion of the upper surface of the unit case 12a. A plurality of indicators 8 are arranged on the central part of the upper surface of the unit case 12a. They serve as indicating means that indicate the operating state of the fuel cell unit 10 and the residual quantity of the fuel cartridge.

The power generation setting switch 112 is a switch that is preset by a user to allow or prohibit power generation in the fuel cell unit 10. For example, it is composed of a slide-type switch. The fuel cell operation switch 116 is used to stop only the power generation in the fuel cell unit 10 without interrupting the operation of the information processor 18 while the processor 18 is being operated by electric power generated by the unit 10. In this case, the information processor 18 continues its operation by using power from a built-in secondary battery. For example, the operation switch 116 is composed of a push switch or the like.

The mounting platform 11 has a flat rectangular shape, extending horizontally from the unit case 12a so that the rear part of the information processor 18 can be placed thereon. A docking connector 14 for use as a terminal junction for connection with the processor 18 is provided on the upper surface of the platform 11. As shown in FIGS. 1 and 2, a docking connector 21 (mentioned later) for use as a terminal junction for connection with the fuel cell unit 10 is provided on, for example, the rear part of the bottom surface of processor 18. When the rear part of the information processor 18 is set on the mounting platform 11, the docking connectors 14 and 21 are connected mechanically and electrically to each other.

Positioning projections 15 and hooks 16 that constitute a locking mechanism are disposed on three spots of the mounting platform 11. The projections 15 and the hooks 16 individually engage engaging holes (not shown) in the rear part of the bottom surface of the information processor 18, thereby positioning and holding the information processor with respect to the mounting platform 11. The mounting platform 11 is provided with an eject button 17, which serves to unlock the locking mechanism in removing the processor 18 from the fuel cell unit 10.

The shape and size of the fuel cell unit 10 shown in FIGS. 1 and 2, the shape and position of the docking connector 14, etc. may be modified variously.

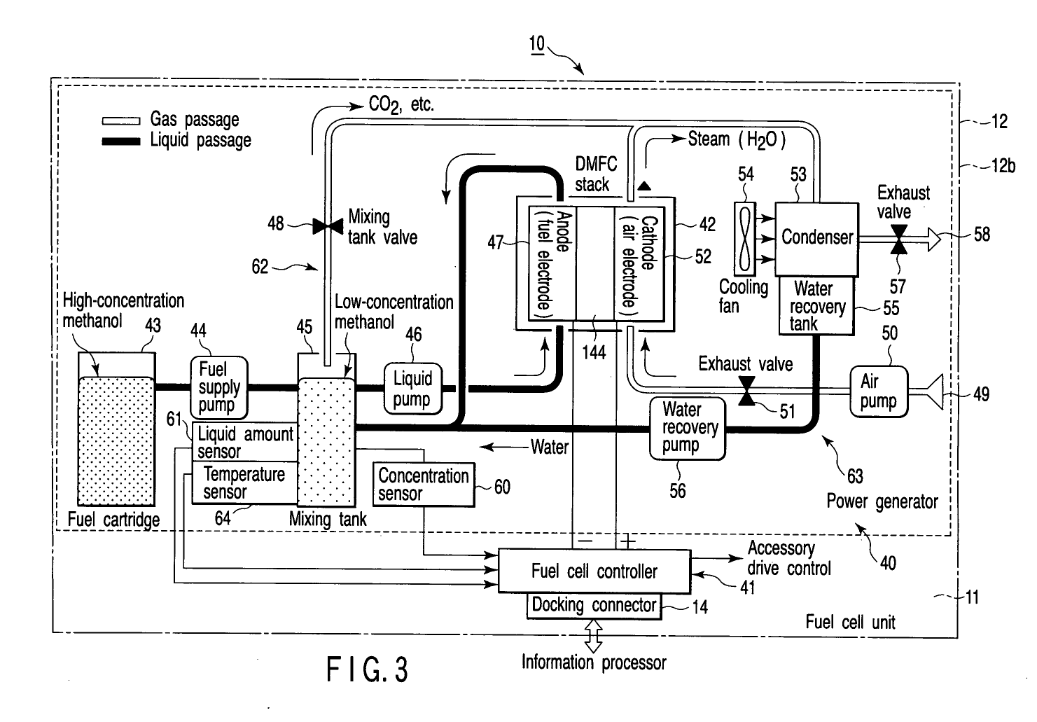

FIG. 3 is an exemplary system diagram showing the fuel cell unit 10 and illustrates details of the DMFC stack and accessories around it.

The fuel cell unit 10 comprises a power generator 40 and a fuel cell controller 41 as control means for the unit 10. The controller 41 serves as a communication control means for communication with the information processor 18, besides controlling the generator 40.

The power generator 40 comprises a DMFC stack 42 that primarily serves for power generation, and a fuel cartridge 43 stored with methanol that forms the fuel. High-concentration methanol is sealed in the cartridge 43. The cartridge 43 is configured to be removable so that it can be easily replaced with a new one when the fuel therein is used up.

In a direct-methanol fuel cell, a crossover phenomenon must be reduced in order to improve the power generation efficiency. Thus, it is effective to dilute the high-concentration methanol to a lower concentration and inject it into a fuel electrode 47. To attain this, the fuel cell unit 10 uses a dilution/circulation system 62, and the power generator 40 is provided with accessories 63 that are needed to realize the system 62.

The dilution/circulation system 62 comprises a liquid passage through which the fuel and other fluids are run and a gas passage through which air and other gases are allowed to flow. The accessories 63 include ones provided in the liquid passage and ones in the gas passage.

The accessories 63 in the liquid passage include a fuel supply pump 44 that is pipe-connected to an output portion of the fuel cartridge 43, a mixing tank 45 connected to an output portion of the pump 44, and a liquid pump 46 connected to an output portion of the mixing tank 45. An output portion of the pump 46 is connected to an anode (fuel electrode) 47 of the DMFC stack 42. An output portion of the anode 47 is pipe-connected to the mixing tank 45. Further, the accessories 63 include a water recovery tank 55 that is disposed adjacent to a condensed gas 3 (mentioned later). An output portion of the tank 55 is pipe-connected to a water recovery pump 56. An output portion of the pump 56 is connected to the mixing tank 45. The fuel cartridge 43, fuel supply pump 44, mixing tank 45, and liquid pump 46 constitute a fuel supply section that supplies the fuel to the DMFC stack 42.

On the other hand, the accessories 63 in the gas passage include an air pump 50, which is connected to a cathode (air electrode) 52 of the DMFC stack 42 through an exhaust valve 51, and a condenser 53 connected to an output portion of the cathode 52. Further, the mixing tank 45 is pipe-connected to the condenser 53 through a mixing tank valve 48. The condenser 53 is connected to an exhaust port 58 through an exhaust valve 57. The condenser 53 is provided with fins that effectively condense steam. A cooling fan 54 is located opposite the condenser 53.

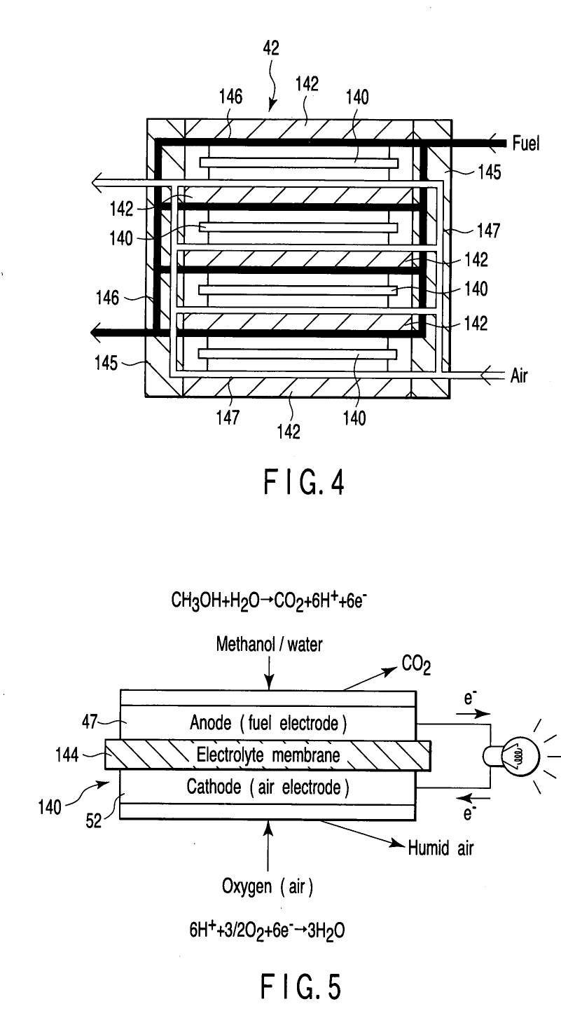

As shown in FIGS. 4 and 5, the DMFC stack 42 for use as a cell stack has a laminate structure and a frame 145. The laminate structure has a plurality of, e.g., four, single cells 140 and five separators 142 in the form of rectangular plates, which are alternately stacked in layers. Each single cell 140 is provided with a membrane electrode assembly (MEA), which integrally comprises the cathode 52 and the anode 47, each in the form of a rectangular plate composed of a catalyst layer and a carbon paper, and a substantially rectangular polymer electrolyte membrane 144 sandwiched between the cathode and the anode. The polymer electrolyte membrane 144 is formed with an area larger than those of the cathode 52 and the anode 47.

Three of the separators 142 are stacked in layers, each between two adjacent single cells 140, while the other two separators are stacked at the opposite ends with respect to the stacking direction. The separators 142 and the frame 145 are formed having a fuel passage 146 for fuel supply to the anode 47 of each single cell 140 and an air passage 147 for air supply to the cathode 52 of the single cell.

The power generation mechanism of the power generator 40 of the fuel cell unit 10 will now be described along flows of the fuel and air (oxygen).

First, as shown in FIG. 3, the high-concentration methanol in the fuel cartridge 43 is supplied to the mixing tank 45 by the fuel supply pump 44. In the mixing tank 45, the high-concentration methanol is mixed with recovered water, low-concentration methanol (residue of power generation reaction) from the anode 47, etc. and diluted, whereupon low-concentration methanol is generated. The low-concentration methanol is controlled so that it can maintain a concentration of, e.g., 3 to 6%, for a high power generation efficiency. This concentration control is achieved as the fuel cell controller 41 controls the amount of high-concentration methanol supplied to the mixing tank 45 by the fuel supply pump 44 in accordance with, for example, the result of detection by a concentration sensor 40. Alternatively, the concentration control may be realized by controlling the amount of circulating water in the mixing tank 45 by means of the water recovery pump 56 or the like.

The mixing tank 45 is provided with a liquid amount sensor 61 for detecting the amount of an aqueous methanol solution in the mixing tank 45 and a temperature sensor 64 for detecting temperature. Results of detection by these sensors are delivered to the fuel cell controller 41 and used for the control of the power generator 40 and the like.

The aqueous methanol solution diluted in the mixing tank 45 is compressed by the liquid pump 46 and fed to the fuel passage 146 of the DMFC stack 42, through which it is injected into the anode 47 of each single cell 140. In the anode 47, as shown in FIG. 5, electrons are generated as the methanol is oxidized. Hydrogen ions (H+) generated by the oxidation reaction are transmitted through the solid polymer electrolyte membrane 144 and reach the cathode 52.

Carbon dioxide that is generated by the oxidation reaction at the anode 47, along with an unoxidized portion of the aqueous methanol solution, is refluxed again to the mixing tank 45. The carbon dioxide is gasified in the mixing tank 45, fed through the gas passage into the condenser 53, and finally, discharged to the outside through the exhaust valve 57 and the exhaust port 58.

As shown in FIG. 3, on the other hand, air (oxygen) is introduced through an intake port 49 and compressed by the air pump 50 that constitutes an air supply section. Thereafter, it is fed into the air passage 147 of the DMFC stack 42 through the exhaust valve 51 and supplied through the air passage to the cathode (air electrode) 52 of each single cell 140. At the cathode 52, reduction of oxygen (O²) advances, whereupon electrons (e⁻) from an external load, hydrogen ions (H+) from the anode 47, and oxygen (O²) produce water (H²O) in the form of steam. This steam is discharged from the cathode 52 and enters the condenser 53. In the condenser 53, the steam is cooled by the cooling fan 54 to water (liquid), which is temporarily stored in the water recovery tank 55. The recovered water is refluxed into the mixing tank 45 by the water recovery pump 56 and forms the dilution/circulation system 62 for diluting the high-concentration methanol.

As seen from this power generation mechanism of the fuel cell unit 10 based on the dilution/circulation system 62, the accessories 63, including the pumps 44, 46, 50 and 56, the valves 48, 51 and 57, the cooling fan 54, etc., are driven to take out electric power from the DMFC stack 42, that is, to start power generation. Thus, the aqueous methanol solution and air (oxygen) are injected into the DMFC stack 42, whereupon an electrochemical reaction advances to produce electric power. The electric power generated in the DMFC stack 42 is supplied to the information processor 18 through the fuel cell controller 41 and the docking connector 14. In stopping the power generation, on the other hand, the drive of the accessories 63 or the takeout of the electric power from the DMFC stack 42 is stopped.

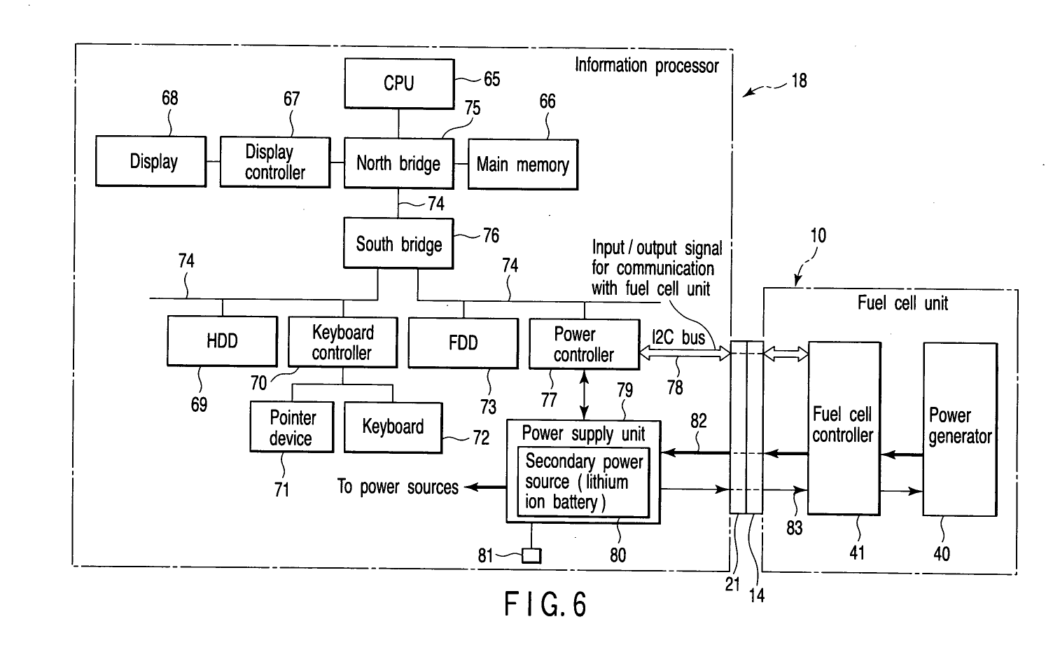

FIG. 6 shows a system configuration of the information processor 18 to which the fuel cell unit 10 according to the present embodiment is connected.

The information processor 18 comprises a CPU 65, main memory 66, display controller 67, display 68 as a display section, hard disc drive (HDD) 69, keyboard controller 70, pointer device 71, keyboard 72 as a input section, and FDD 73. The processor 18 further comprises a bus 74 that transfers signals between these components, north and south bridges 75 and 76, which are devices for converting the signals transferred through the bus 74, and the like. Furthermore, a power supply unit 79, which holds therein a secondary battery 80, such as a lithium ion battery, is disposed in the information processor 18. The power supply unit 79 is controlled by a power controller 77.

The CPU 65 serves to control the operation of the entire information processor 18, and it executes various programs for an operating system (OS), utility software including a power management utility, application software, etc. that are stored in the main memory 66.

A control-system interface and a power-system interface are provided as electrical interfaces between the fuel cell unit 10 and the information processor 18. The control-system interface is an interface for communication between the power controller 77 of the information processor 18 and the fuel cell unit 10. The communication between the processor 18 and the unit 10 through the control-system interface is made by means of a serial bus, such as an I2C bus 78.

The power-system interface is an interface for power transfer between the fuel cell unit 10 and the information processor 18. For example, electric power generated by the DMFC stack 42 of the power generator 40 is supplied to the information processor 18 through the fuel cell controller 41 and the docking connectors 14 and 21. The power-system interface includes a power supply 83 from the power supply unit 79 of the processor 18 to the accessories 63 in the fuel cell unit 10.

DC source power, obtained by AC/DC conversion, is supplied to the power supply unit 79 of the information processor 18 through an AC adapter connector 81, whereby the processor 18 can be activated, and the secondary battery 80 can be charged.

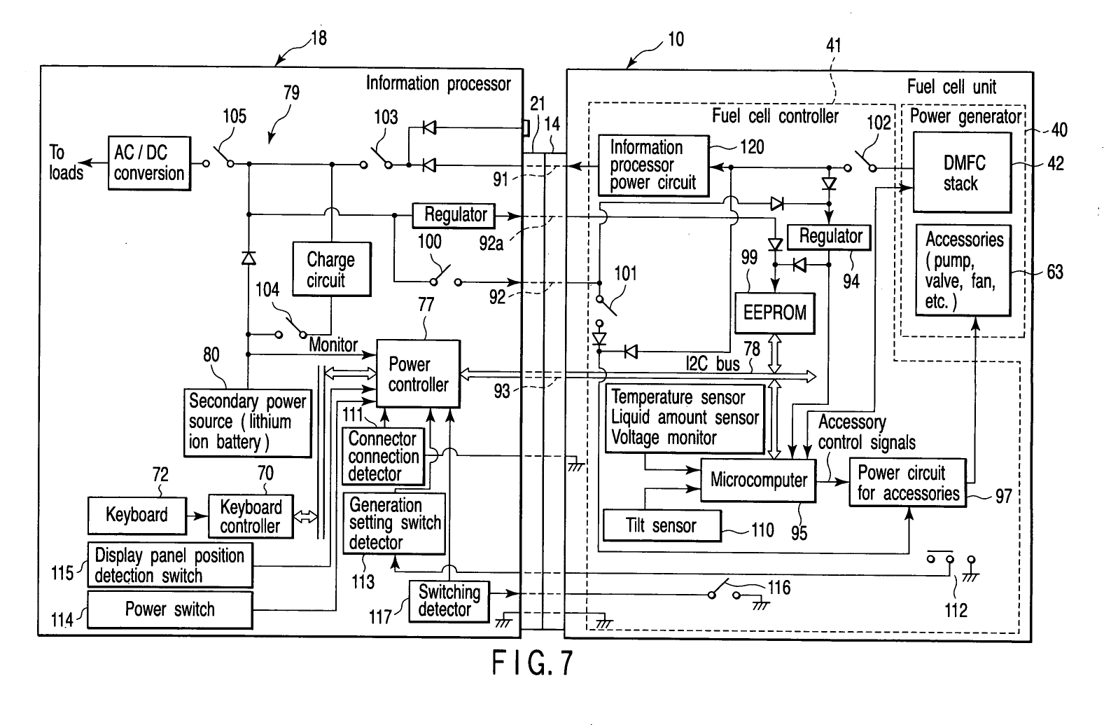

FIG. 7 is a configuration diagram showing connection between the fuel cell controller 41 of the fuel cell unit 10 and the power supply unit 79 of the information processor 18.

The fuel cell unit 10 and the information processor 18 are connected mechanically and electrically to each other by the docking connectors 14 and 21. The docking connectors 14 and 21 have a first power terminal (output power terminal) 91 and a second power terminal (input power terminal for accessories) 92. Electric power generated by the DMFC stack 42 of the power generator 40 is supplied to the information processor 18 through the first power terminal 91. The second power terminal 92 is used when source power is supplied from the processor 18 to a microcomputer 95 of the fuel cell unit 10 through a regulator 94 and when source power is supplied to a power circuit 97 for accessories through a switch 101. Further, the docking connectors have a third power terminal 92a through which source power is supplied from the processor 18 to a writable nonvolatile memory (EEPROM) 99.

The docking connectors 14 and 21 have a communication input/output terminal 93 for communication between the power controller 77 of the information processor 18 and the microcomputer 95 of the fuel cell unit 10 or the EEPROM 99. The microcomputer 95 serves also as a detector for detecting the output power of the DMFC stack 42. The detected output power, e.g., an output current value in this case, is loaded into the EEPROM 99.

Referring now to FIG. 7, there will be described a basic flow of processing such that electric power from the DMFC stack 42 in the fuel cell unit 10 is supplied to the information processor 18. Now let it be supposed that the secondary battery (lithium ion battery) 80 of the information processor 18 is charged with predetermined electric power and that all the switches shown in FIG. 7 are open.

Based on a signal outputted from a connector connection detector 111, the information processor 18 recognizes that it is connected mechanically and electrically to the fuel cell unit 10. This recognition is made as the connection detector 111 detects, based on an input signal received thereby, for example, that it is grounded in the fuel cell unit 10 when the docking connectors 14 and 21 are connected to each other.

The power controller 77 of the information processor 18 determines whether the power generation setting switch 112 is set in a generation permitting mode or a generation prohibiting mode. In response to an input signal received by a generation setting switch detector 113, for example, the detector 113 detects whether the power generation setting switch 112 is grounded or open, depending on the setting state of the power generation setting switch 112. If the switch 112 is open, the power controller 77 concludes that the generation prohibiting mode is established.

When the information processor 18 and the fuel cell unit 10 are mechanically connected to each other by the docking connectors 14 and 21, source power is supplied from the processor 18 to EEPROM 99 as a storage section of the fuel cell controller 41 through the third power terminal 92a. The EEPROM 99 is previously stored with status information on the fuel cell unit 10 and the like. The status information may include, for example, a parts code, serial number, or rated output of the fuel cell unit 10, detected output current value of the DMFC stack 42, and detected data, such as the liquid amount, temperature, concentration, etc., detected by the various sensors. The EEPROM 99 is connected to a serial bus, such as the I2C bus 78, and data stored in the EEPROM 99 can be read while the source power is being supplied to the EEPROM 99. The power controller 77 can read the status information from the EEPROM 99 through the communication input/output terminal 93 and store it into a built-in register or the like.

In this state, the fuel cell unit 10 is not performing power generation, and its interior is kept so that no source power than that for the EEPROM 99 is supplied.

If the user sets the power generation setting switch 112 in the generation permitting mode, the power controller 77 in the information processor 18 is enabled to read identification information stored in the EEPROM 99 in the fuel cell unit 10. Preferably, the power generation setting switch should be a slide switch or any other suitable switch that can be kept open or closed.

If it is concluded, based on the identification information read from the EEPROM 99 in the fuel cell unit 10, that the unit 10 connected to the information processor 18 is compatible with the processor 18, the power controller 77 closes a switch 100 that is attached to the processor 18. Thereupon, electric power from the secondary battery is supplied to the fuel cell unit 10 through the second power terminal 92, and source power is supplied to the microcomputer 95 through the regulator 94. In this state, the switch 101 in the fuel cell unit 10 is open, and no source power is supplied to the power circuit 97 for accessories. Thus, the accessories 63 are not operating in this state.

Having already started operation, however, the microcomputer 95 is ready to receive various control commands from the power controller 77 of the information processor 18. Further, the microcomputer 95 is ready to transmit power supply information of the fuel cell unit 10 to the processor 18.

When a generation start command is delivered from the power controller 77 to the fuel cell controller 41 in this state, the controller 41 controls the microcomputer 95 to close the switch 101, whereupon source power is supplied from the information processor 18 to the power circuit 97 for accessories. In response to accessory control signals transmitted from the microcomputer 95, at the same time, the controller 41 drives the accessories 63 in the power generator 40, that is, the pumps 44, 46, 50 and 56, valves 48, 51 and 57, cooling fan 54, etc. Further, the microcomputer 95 closes a switch 102 in the fuel cell controller 41.

In consequence, the aqueous methanol solution and air are injected into the DMFC stack 42, and power generation is started. Electric power generated by the DMFC stack 42 starts to be supplied to the information processor 18 through an information processor power circuit 120 in the fuel cell controller 41. Since the generated power output cannot instantaneously reach a rated value, however, a warm-up mode is maintained so that the rated value is reached.

The microcomputer 95 of the fuel cell controller 41 monitors, for example, the output voltage and temperature of the DMFC stack 42. When it concludes that a rated value is reached by the output of the stack 42, the microcomputer 95 opens the switch 101 of the fuel cell unit 10, thereby switching the source of power supply to the accessories 63 from the information processor 18 to the DMFC stack 42.

The following is a description of an appropriate method of recovery processing for lowered output of the DMFC stack 42.

If water mainly produced at the cathodes 52 of the single cells 140 that constitute the DMFC stack 42 stands in the air passage 147 of the stack 42, thereby preventing air from permeating into the cells 140, owing to prolonged use, the balance of fuel and air supply is broken, so that the output current value or generated power output of the DMFC stack 42 is reduced.

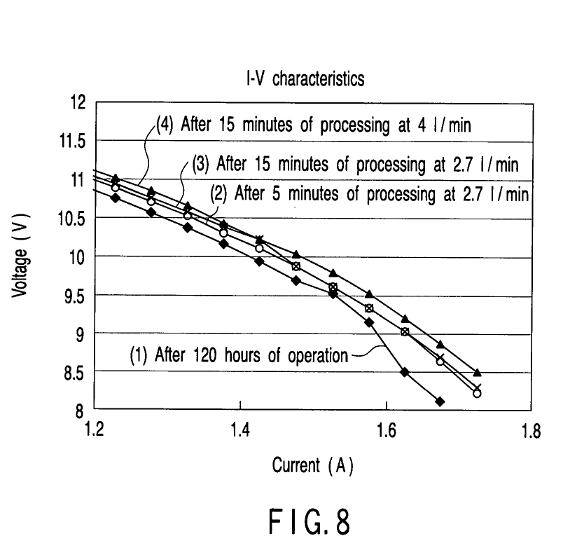

FIG. 8 shows current-voltage characteristics of the DMFC stack 42. In FIG. 8, a characteristic curve 1 represents a characteristic obtained after the fuel cell unit 10 is operated for 120 hours. In this case, the output current value lowers at points near low voltages of 8 to 9V. If the power generation is continued in a low-output state, the efficiency of power supply lowers, and the heat generation rate increases, possibly resulting in breakage of the cells.

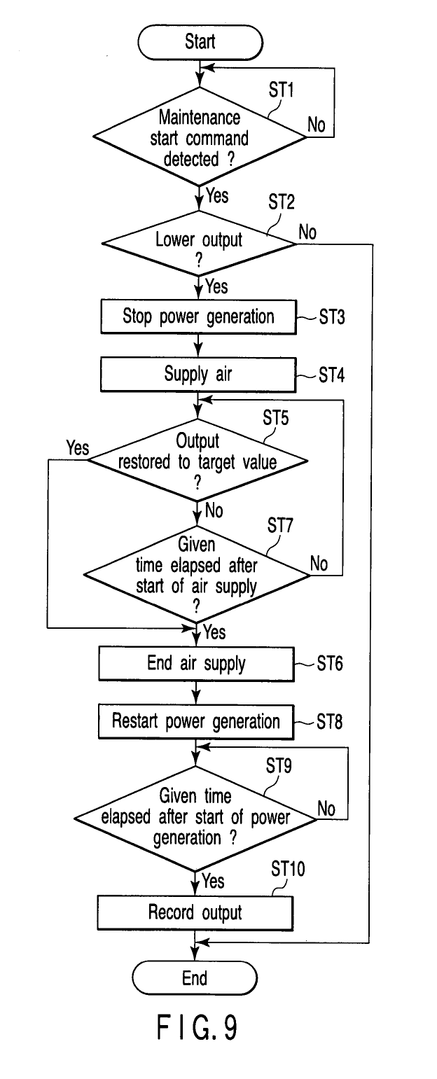

Thus, in the fuel cell system, recovery processing for the fuel cell unit 10 is carried out if such an output reduction occurs in the fuel cell system or at the user's desired timing. Operation for the recovery processing will now be described with reference to the flowchart of FIG. 9.

While operation for power generation by the DMFC stack 42 is being performed, the microcomputer 95 of the fuel cell controller 41 monitors the output current value of the stack 42, stores the detected output current value into the EEPROM 99, and updates it as required. If the user selects execution of the recovery processing based on the power management utility stored in the main memory 66, a maintenance start command is outputted from the CPU 65 of the information processor 18. Thereupon, a maintenance mode, i.e., the recovery processing, is started.

When the power controller 77 detects the maintenance start command (ST1), it fetches the status information on the fuel cell unit 10 from the EEPROM 99 of the fuel cell unit 10 in response to this command. Then, the power controller 77 compares the fetched output current value of the DMFC stack 42 with a preset reference output, e.g., a rated output value in this case, and determines whether or not the output current value of the stack 42 is lower than the rated output value (ST2).

If the output current value is lower by a given or larger margin, the power controller 77 causes the microcomputer 95 of the fuel cell unit 10 to stop power generation in the power generator 40 (ST3). The power generation is stopped by, for example, opening the switch 102 to stop the output from the DMFC stack 42. If the output current value is not lower by the given or larger margin, on the other hand, the maintenance mode is terminated.

After the power generation is stopped, the microcomputer 95 of the fuel cell unit 10, under the control of the power controller 77, drives the air pump 50 of the power generator 40 for, e.g., 5 to 15 minutes. Thereupon, air that is introduced through the intake port 49 and pressurized by the pump 50 is run into the air passage 147 of the DMFC stack 42 (ST4). As this is done, the power generation by the DMFC stack 42 is stopped, and generation of water on the cathode 52 side is also stopped. By running the compressed air into the fuel passage 147, therefore, the water standing in the air passage 147 can be discharged from the DMFC stack 42 and delivered to the water recovery tank 55. Thus, air can be smoothly supplied to the cathode 52, so that the reduction of the output of the DMFC stack 42 can be compensated for. The air feed capacity or air supply rate of the air pump during the maintenance processing and the air supply time of the air pump are previously set to predetermined values by the power controller 77 and stored in the main memory 66. The air supply rate of the air pump during the maintenance processing is set to a value equal to or higher than the value for normal operation for power generation.

During the air supply, the power controller 77 detects the output current value of the DMFC stack 42, thereby determining whether or not the output current value is restored to a rated current value (ST5). If the rated value is recovered, the air supply by the air pump 50 is finished (ST6). If not, the power controller 77 determines whether or not a predetermined time period has elapsed since the start of the air supply by the air pump 50 (ST7). When the predetermined time period is up, the air supply by the air pump 50 is finished (ST6).

Thereafter, the power controller 77 closes the switch 102 under the control of the microcomputer 95 of the fuel cell unit 10, thereby starting the power generation of the power generator 40 (ST8). After the passage of a fixed time period since the start of the power generation (ST9), the microcomputer 95 detects the output current value of the DMFC stack 42 after the recovery processing and records it in the EEPROM 99 (ST10). Thereupon, the maintenance mode terminates, and the recovery processing is completed.

FIG. 8 shows current-voltage characteristics of the DMFC stack 42 obtained when the recovery processing is performed. In FIG. 8, characteristic curves 2, 3 and 4 represent current-voltage characteristics for cases where the recovery processing is performed at the air supply rates of 2.7 1/min, 2.7 1/min, and 4 1/min for 5 minutes, 15 minutes, and 15 minutes, respectively. These characteristics indicate that the output current value is increased to achieve the recovery by the aforesaid recovery processing.

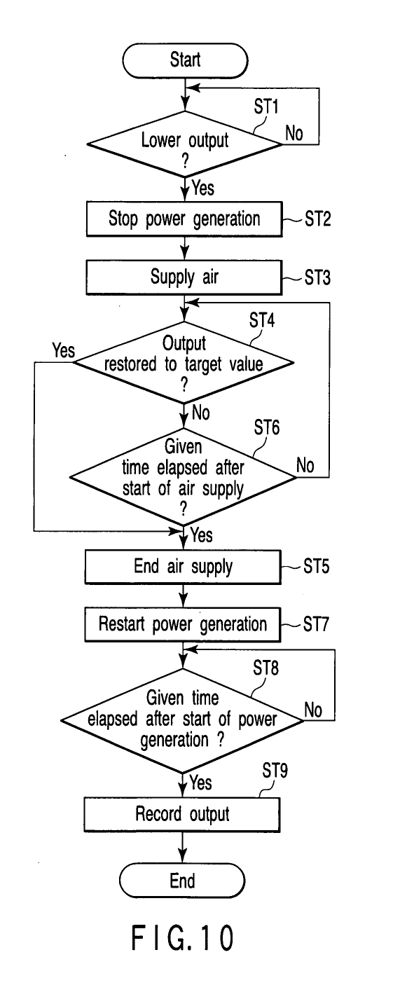

In the embodiment described above, the recovery processing is performed as required in response to the maintenance start command from the user. Alternatively, however, the information processor 18 may be configured so that its power controller 77 can automatically executes the recovery processing when the output of the DMFC stack is lowered. The automatic operation for the recovery processing will now be described with reference to the flowchart of FIG. 10.

While the operation for power generation by the DMFC stack 42 is being performed, the microcomputer 95 of the fuel cell controller 41 monitors the output current value of the stack 42, stores the detected output current value into the EEPROM 99, and updates it as required. The power controller 77 of the information processor 18 periodically fetches the status information on the fuel cell unit 10 from the EEPROM 99. Then, the controller 77 compares the output current value of the DMFC stack 42 with the preset reference output, e.g., the rated output value in this case, and determines whether or not the output current value of the stack 42 is lower than the rated output value (ST1). In the description herein, “periodically” is supposed to imply the concept of “continually.” If the output current value is lower by the given or larger margin, the power controller 77 starts the maintenance mode under the control of the CPU 65.

The power controller 77 causes the microcomputer 95 of the fuel cell unit 10 to stop the power generation in the power generator 40 (ST2). The power generation is stopped by, for example, opening the switch 102 to stop the output from the DMFC stack 42.

After the power generation is stopped, the microcomputer 95 of the fuel cell unit 10, under the control of the power controller 77, drives the air pump 50 of the power generator 40 for, e.g., 5 to 15 minutes. Thereupon, air that is introduced through the intake port 49 and pressurized by the pump 50 is run into the air passage 147 of the DMFC stack 42 (ST3). As this is done, the power generation by the DMFC stack 42 is stopped, and generation of water on the cathode 52 side is also stopped. By running the compressed air into the fuel passage 147, therefore, the water standing in the air passage 147 is discharged from the DMFC stack 42 and delivered to the water recovery tank 55. Thus, air can be smoothly supplied to the cathode 52, so that the reduction of the output of the DMFC stack 42 can be compensated for. The air feed capacity of the air pump may be set to a value equal to or higher than the value for normal operation for power generation.

During the air supply, the power controller 77 detects the output current value of the DMFC stack 42, thereby determining whether or not the output current value is restored to the rated current value (ST4). If the rated value is recovered, the air supply by the air pump 50 is finished (ST5). If not, the power controller 77 determines whether or not the predetermined time period has elapsed since the start of the air supply by the air pump 50 (ST6). When the predetermined time period is up, the air supply by the air pump 50 is finished (ST5).

Thereafter, the power controller 77 closes the switch 102 under the control of the microcomputer 95 of the fuel cell unit 10, thereby starting the power generation of the power generator 40 (ST7). After the passage of the fixed time period since the start of the power generation (ST8), the microcomputer 95 detects the output current value of the DMFC stack 42 after the recovery processing and records it in the EEPROM 99 (ST9). Thereupon, the maintenance mode terminates, and the recovery processing is completed.

According to the fuel cell system constructed in this manner and its operation control method, air can be supplied to the DMFC stack by using the air pump, which constitutes a basic component of the fuel cell unit, whereby the output reduction can be compensated for. Accordingly, the output reduction of the fuel cell can be prevented without separately providing any nitrogen supply means or the like for the recovery processing. Further, the recovery processing to counter the output reduction of the DMFC stack can be executed arbitrarily or automatically under the control of the information processor to which the fuel cell unit is connected, and the fuel cell unit can be combined with various types of information processors. Thus, there may be provided a fuel cell system and its operation control method, in which the output reduction of the fuel cell can be efficiently compensated for without increasing the size of the information processor.

While certain embodiments of the invention have been described, these embodiments have been presented by way of example only, and are not intended to limit the scope of the invention. Indeed, the novel methods and systems described herein may be embodied in a variety of forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

Although the fuel cell unit is configured to be connected to the outside of the information processor, for example, it may alternatively be contained in the information processor. The number of stacked single cells in the DMFC stack is not limited to the number employed in the foregoing embodiment, but may be increased or decreased, if necessary. The air supply rate, operating time, etc. of the air pump are not limited to the values according to the foregoing embodiment, but may be variously selected. The fuel cell system according to this invention is not limited to the personal computer described herein, but may be also applied to any other electronic devices, such as mobile devices, portable terminals, etc. The fuel cell may be a polymer electrolyte fuel cell (PEFC) or any other type than a DMFC.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A fuel cell system comprising:
an information processor and a fuel cell unit connected to the information processor,
the fuel cell unit including:
a cell stack which comprises a plurality of single cells, stacked in layers on one another and each having an anode and a cathode opposed to each other, a fuel passage through which a fuel is supplied to the anode, and an air passage through which air is supplied to the cathode, and generates electric power based on a chemical reaction,
a fuel supply section which supplies a fuel to the anode through the fuel passage,
an air supply section which supplies air to the cathode through the air passage, and
a cell controller which detects a generated power output of the cell stack and controls operations of the fuel supply section and the air supply section,
the information processor comprising an input section through which information is inputted, a display section which displays the information, and a power controller which manages an operation of the fuel cell unit, the power controller being configured to stop power generation in the cell stack and execute maintenance processing wherein air from the air supply section is caused to flow through the air passage of the cell stack, when the generated power output of the cell stack is lower than a predetermined output.

2. The fuel cell system according to claim 1, wherein the power controller detects the generated power output of the cell stack when a maintenance processing start command is inputted through the input section and executes the maintenance processing when the detected generated power output is lower than the predetermined output.

3. The fuel cell system according to claim 1, wherein the power controller periodically detects the generated power output of the cell stack and executes the maintenance processing when the detected generated power output is lower than the predetermined output.

4. The fuel cell system according to claim 1, wherein the fuel cell unit comprises a storage section which stores status information on the fuel cell unit including the generated power output, and the power controller of the information processor fetches the status information on the fuel cell unit from the storage section of the fuel cell unit and compares the generated power output of the cell stack with the predetermined output.

5. The fuel cell system according to claim 1, wherein the power controller stops air supply from the air supply section to the air passage of the cell stack and restarts the power generation in the cell stack when the generated power output of the cell stack is restored to the predetermined output in the maintenance processing.

6. The fuel cell system according to claim 1, wherein the power controller sets an air supply rate and an air supply time of the air supply section in the maintenance processing.

7. The fuel cell system according to claim 6, wherein the power controller stops air supply from the air supply section to the air passage of the cell stack and restarts the power generation in the cell stack after the passage of the set air supply time in the maintenance processing.

8. A method of controlling an operation of a fuel cell system which comprises an fuel cell unit, including a cell stack which has a plurality of single cells, stacked in layers on one another and each having an anode and a cathode opposed to each other, a fuel passage through which a fuel is supplied to the anode, and an air passage through which air is supplied to the cathode, and generates electric power based on a chemical reaction, a fuel supply section which supplies the fuel to the anode through the fuel passage, an air supply section which supplies air to the cathode through the air passage, and a cell controller which detects a generated power output of the cell stack and controls operations of the fuel supply section and the air supply section; and an information processor which includes an input section through which information is inputted, a display section which displays the information, and a power controller which manages an operation of the fuel cell unit, and is connected to the fuel cell unit, the method comprising:
detecting the generated power output of the cell stack; and
stopping power generation in the cell stack by the power controller and executing maintenance processing wherein air from the air supply section is caused to flow through the air passage of the cell stack, when the generated power output of the cell stack is lower than a predetermined output.

9. The method according to claim 8, wherein the executing maintenance processing includes detecting the generated power output of the cell stack when a maintenance processing start command is inputted through the input section of the information processor, and executing the maintenance processing when the detected generated power output is lower than the predetermined output.

10. The method according to claim 8, wherein the executing maintenance processing includes periodically detecting the generated power output of the cell stack, and executing the maintenance processing when the detected generated power output is lower than the predetermined output.
